(19) United States
(12) Patent Application Publication
(10) Pub. No.: US 2012/0195196 A1
(43) Pub. Date: Aug. 2, 2012

(54) SYSTEM AND METHOD FOR QoS CONTROL OF IP FLOWS IN MOBILE NETWORKS

(76) Inventors: Rajat Ghai, Sandwich, MA (US); Yuyong Zhang, Nashua, NH (US); Vinayak Antarkar, Charlestown, MA (US); Vinay Avasthi, Bangalore (IN)

(21) Appl. No.: 13/197,051

(22) Filed: Aug. 3, 2011

Related U.S. Application Data
(60) Provisional application No. 61/372,735, filed on Aug. 11, 2010.

(51) Int. Cl. H04W 28/10

(52) U.S. Cl. 370/235

(57) ABSTRACT

A system and methods for application control which enable the delivery of Rich Internet Applications such as HD/Video Stream, Gaming, and Webservice delivery over mobile operator's PLMN is disclosed. The methods define Application Program Interfaces for Application Service Providers for delivering rich applications such as NetFlix Video service, Interactive Network Gaming etc., over wireless mobile network using state of the art web protocols such as HTTP, RTMP etc. The platform that incorporates these methods interacts with 3GPP/UMTS/LTE/CDMA defined standard compliant network devices using the standard network interfaces and present application specific control function. It further identifies extensions to the logical interfaces defined by the corresponding standards (3GPP, 3GPP2 etc.). Additionally, methods and procedures for controlling QoS in the transit network gateways, such as SGSN, GGSN, or P-GW, while delivering application traffic, are also disclosed.

This application claims priority from U.S. Provisional Patent Application Ser. No. 61/372,735, filed Aug. 11, 2010, the disclosure of which is incorporated herein by reference in its entirety.

### BACKGROUND

A PLMN (Public Land Mobile Network) is a wireless network that is operated by recognized and authorized organizations called wireless service providers. A PLMN uses radio waves within a licensed spectrum to create a telecommunication network for the specific purpose of providing mobile telecommunications service to the public. A mobile service provides continuous connectivity amongst mobile devices or between mobile devices to a fixed network.

PLMNs use cellular telephony, which is characterized by the use of radio cells that provide radio coverage for a geographic area, with multiple cells arranged to provide contiguous radio coverage over a larger area. Wired communication is used in portions of a PLMN, such as between cells or access points and gateways to create entry/exit points to internet.

FIG. 1 shows a Typical PLMN 10 that consists of an access network (AN) 20 that is specific to wireless technologies and a core network (CN) 30 that performs routing of mobile communication within the PLMN or from PLMN to external Packet Data Networks (PDNs), such as the internet 40.

PLMNs have evolved over the years tracking the advancements in cellular technologies. The first generation (1G) cellular technology used analog mobile phones, wherein analog information signals were modulated and transmitted. Second generation (2G) systems used digital modulation of the information signals to provide more dense and robust wireless systems. Of the many 2G wireless technologies, the most prevalent ones used code division multiple access (CDMA) technologies for IS-95 systems or time division multiplex access (TDMA) technology for GSM systems to distinguish multiple users. 2G wireless networks are primarily used for speech communication. With the advent of internet and the demand to access internet from portable mobile devices, CDMA based networks were further upgraded to handle higher-speed packet data using CDMA 1x-EVDO in networks referred to as 2.5G while GSM based networks were upgraded to GPRS/EDGE and then HSPA as 3G networks. 3G networks are evolving to 4G technology, which is referred to as long term evolution-system architecture evolution (LTE-SAE) and uses orthogonal frequency division multiple access (OFDMA) technology. Other 4G wireless technologies have also developed including WiMAX (an implementation of IEEE 802.16), WiFi (an implementation of various IEEE 802.11 protocols), and HiperMAN, which is based on an ETSI alternative to IEEE 802.16. 4G networks are based on IP (Internet Protocol) technology to facilitate ultra fast IP packet transmission services.

The range of the wireless communication technology can vary depending on the deployment of the PLMN. A macro cell transceiver is typically used by service providers to provide coverage over about three miles. A pico cell transceiver can provide coverage over about a quarter mile while a femto cell transceiver can provide coverage over 50 to 100 yards that is similar in coverage to a WiFi (WLAN) access point and can be used to provide network access over a short range.

PLMNs use wireless communication technologies to provide speech and data communication services to mobile/portable devices, such as laptop and notebook computers, running many applications, such as web browsers to access the internet, portable digital assistants (PDAs), and bespoke mobile devices, such as cellular telephones, and user equipment (UE). Users, authorized for the wireless service, can connect to a network, such as the Internet, as long as the user is within range of such a wireless communication technology.

For the PLMNs, a part of the evolution of packet based communications has been the development of a core network capable of routing IP based data communication within a PLMN (mobile to mobile) or PLMN to an external network (e.g. mobile to internet).

IP packet core network functionality is developed by three different groups for inclusion in two different topologies: Global System for Mobile Communications (GSM), CDMA 2000 and WiMAX. The 3rd Generation Partnership Project (3GPP) is responsible for General Packet Radio Service (GPRS) which works with GSM/LTE systems, the 3rd Generation Partnership Project 2 (3GPP2) is responsible for High Rate Packet Data (HRPD) which is used with CDMA systems and WiMAX forum responsible for Access Service Network (ASN) and Connectivity Service Network (CSN).

For 3G UMTS based technologies, this packet core network is referred to GPRS (General Packet Radio Service) CN 110. GPRS is an architectural framework for delivering internet protocol (IP) transmission services to mobile nodes as shown in FIG. 2. Main components of a GPRS core network that provide packet services are a SGSN (Serving GPRS Service Node) 120 and a GGSN (Gateway GPRS Service Node) 130. A SGSN 120 manages initial authentication, authorization, mobility, IP session establishment and charging aspects of Packet data communications for the mobile nodes. A GGSN 130 manages IP address allocation to the mobile nodes, gathers charging details for the amount of data packets transmitted by the mobile nodes, enforces policies of the PLMN operator and provides connectivity to external packet data networks (PDNs), such as the internet.

For LTE based technologies, the packet core network is referred to as EPC (Evolved Packet Core). EPC is an architectural framework for delivering internet protocol (IP) transmission services to mobile nodes as shown in FIG. 3. Main components of an EPC core network that provide packet services are a Mobility Management Entity (MME) 210, Serving Gateway (SGW) 220 and a PDN Gateway (PGW) 230. The MME 210 manages initial authentication, authorization, mobility, IP session establishment and charging aspects of Packet data communications for the mobile nodes. The SGW 220 and PGW 230 manage IP address allocation to the mobile nodes, gather charging details for the amount of data packets transmitted by the mobile nodes, enforces policies of the PLMN operator and provides connectivity to external packet data networks (PDNs).

In a CDMA based HRPD core network, shown in FIG. 4, the Packet Data Service Node (PDSN) 260 and Home Agent (HA) 270 provide the architectural framework for delivering internet protocol (IP) transmission services to the mobile node.

In a WiMAX core network Access Service Network Gateway (ASN-GW) and Core Service Network Gateway (CSN GW) or HA provide the architectural framework for delivering internet protocol (IP) transmission services to the mobile node.

Demand for mobile internet has seen steady growth. It is expected that worldwide demand for IP connectivity and transmission worldwide from mobile devices using wireless networks will be approx 26,000 peta Bytes per day. This is roughly equivalent to data transmission of “all the books ever written” multiplied a thousand times.

The current architecture of the PLMN core network for GPRS, HRPD or WiMAX (CSN) is not suitable to scale to such high data throughput required for mobile internet without extraordinarily high cost and complexity.

With high demand for mobile internet usage, new revenue streams for can be realized by providing programmability and interworking of the mobile internet core network and IMS core network with the World Wide Web.

3GPP Standards define Policy and Charging Control Architecture, (TS23.203) defines framework for IP Multimedia Subsystem (IMS) based services. IMS based applications interact with Application Function (AF) component, which interacts with Policy Charging and Rules Function (PCRF), using the RX logical interface. The IMS based service functions are session based, in the sense that when a new IP-CAN (IP Connectivity Access Network) session is established, the corresponding Quality of Service (QOS) and Charging functions are validated and enforced through the PCRF. The PCRF, in turn, identifies the corresponding Policy and Charging Control (PCC) rules and propagates these to the Policy and Charging Enforcement Function (PCEF). Additionally, the PCC architecture also defines flow based charging and QOS control, where flow is defined based on the IP Source, IP Destination, the TCP/UDP Source Port, the TCP/UDP DST Port, and the protocol field.

In addition, online charging system (OCS) is also defined in the 3GPP standards.

Web-based Rich Internet services, and other applications such Video on Demand (VOD) services and gaming services, all use HTTP Transport, and may use dynamic port numbers which may not be specific to the application. Additionally, these functions may be dependent on:
specific websites,
specific types of content, such as high definition (HD), or
available time frame in which the DRM rights of a specific content have been granted by the content owner to the specific website or publisher.

Moreover, when users access these applications or web-services, these accesses are through the normal web-browsing, until the specific application/premium content is accessed. This discovery process and internet accesses happen via typical web browsing, and do not require any additional interactions with PCC interfaces.

It is desirable that an Application Service Provider (ASP) invokes the triggers for the actual delivery of those services that require enhanced QOS/Traffic management features for only the corresponding flows and not for entire user sessions for the same user or from the same web-site. Additionally, it is desirable that the delivery of these services does not require additional 3GPP/PLMN Control plane interactions, such as setting up additional IP-CAN sessions per prior-art 3GPP standards.

### SUMMARY OF THE INVENTION

The current invention discloses a system and method that allows an ASP to invoke triggers for the actual delivery of premium services. To implement this method, a new logical module or device referred to as the WebKitPlatform (WKP), is introduced. The WKP may be a separate hardware device that incorporates these inventive methods or may be a logical module that could be embedded in another network device. Systems and methods are provided in the WKP to provide programmability to other third party applications. These third party applications may use REST/SOAP/XML based Application Programming Interface (APIs) to install rules that trigger certain actions when the triggering criterion is met.

### BRIEF DESCRIPTION OF THE FIGURES

FIG. 1 represents a wireless network of the prior art;

FIG. 2 represents a GPRS network of the prior art;

FIG. 3 represents an EPC network of the prior art;

FIG. 4 represents a HRPD network of the prior art;

FIG. 5 represents a block diagram according to one embodiment of the present invention;

FIG. 6 represents a block diagram according to another embodiment of the present invention;

FIG. 7 represents a block diagram according to another embodiment of the present invention;

FIG. 8 represents a flow to install a new service;

FIG. 9 represents a flow to terminate a new service;

FIG. 10 represents a flow to react to changes in the service;

FIG. 11 represents a flow to request a modification to an existing service; and

FIG. 12 represents a flow showing the use of an API to modify parameters of a user device.

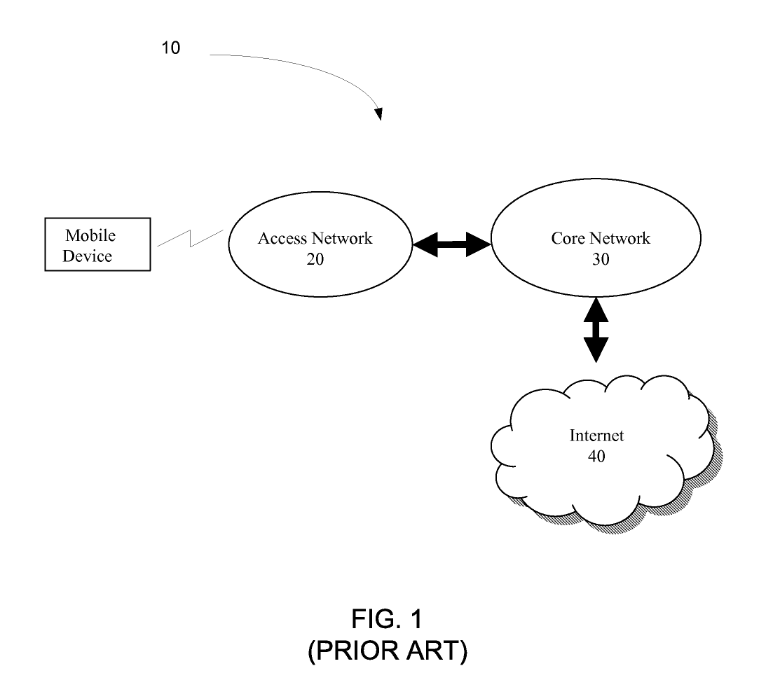

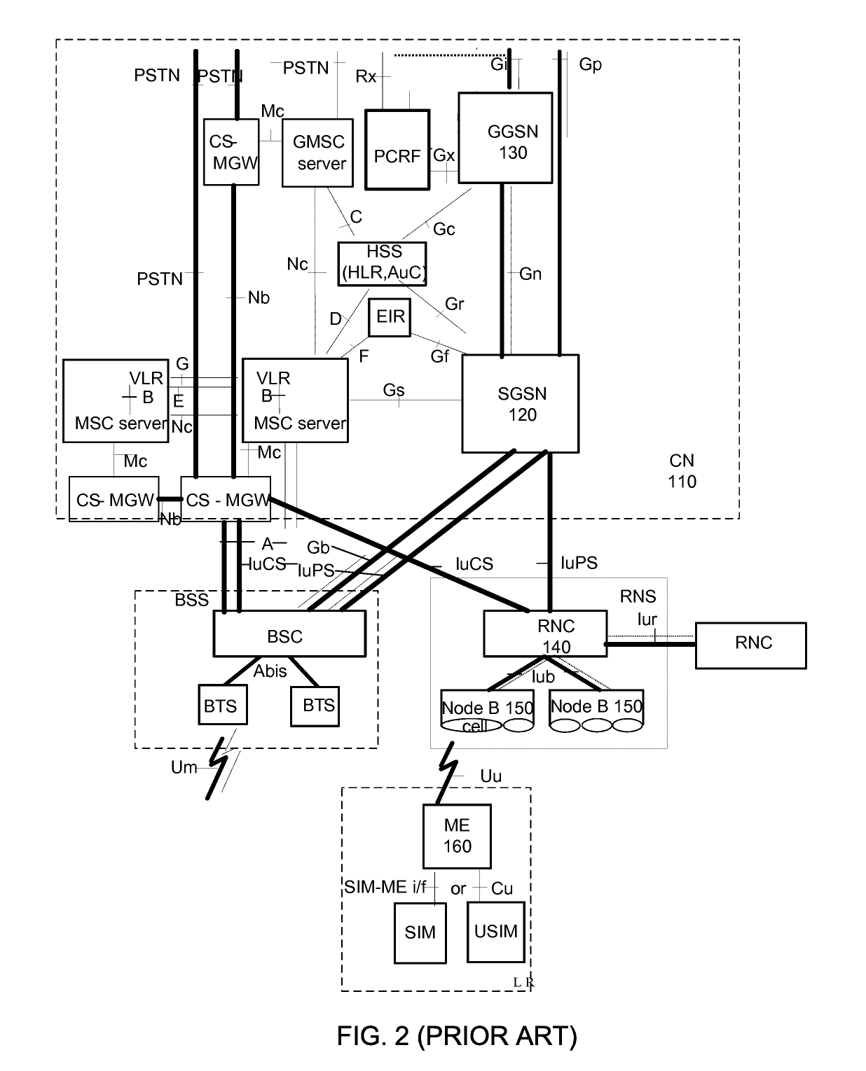

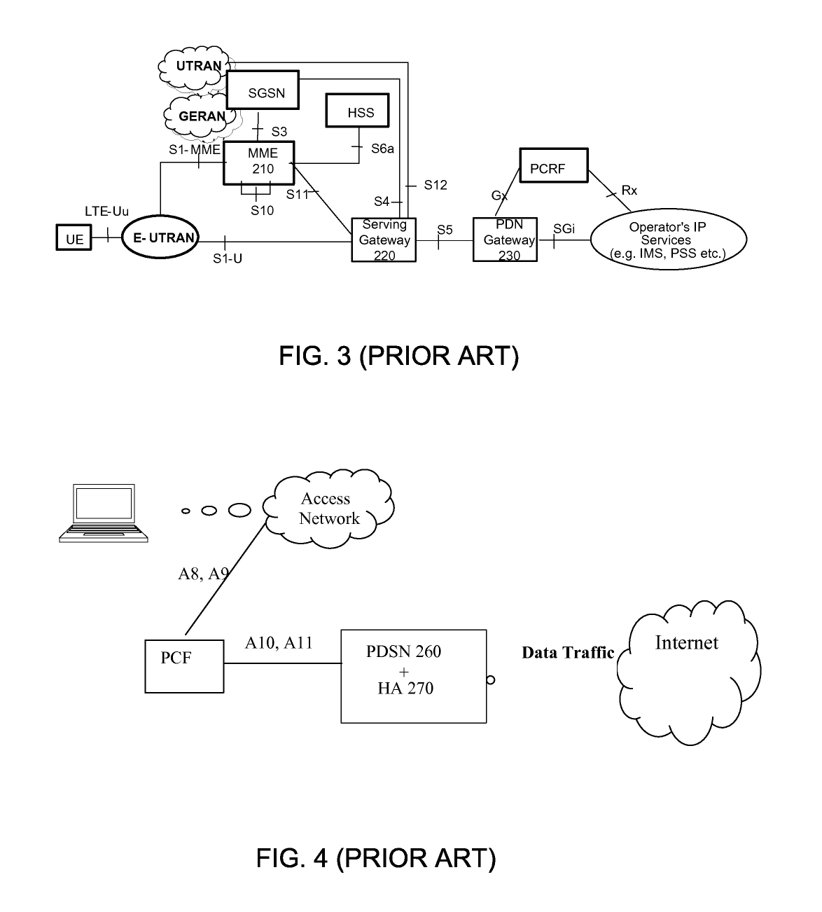

### DETAILED DESCRIPTION OF THE INVENTION

As described above, the present invention discloses a WebKitPlatform (WKP), which may be a dedicated hardware component, or may be a software component incorporated in another existing network component. When implemented as a dedicated hardware component, the WKP has two interface modules, each of which is adapted to implement the signaling required for the choice interface and the associated software protocol. Each interface module is adapted to receive and transmit on the selected interface. Information is processed by the WKP using dedicated control logic or a processing unit. The control logic/processing unit may have its own local storage element, which contains instructions to execute and local status. This storage element may be RAM or DRAM. In addition, at least a portion of this storage element may be non-volatile, such as ROM, FLASH ROM, hard disk, Solid State Disk, or the like. Using known specifications and protocols, the control logic/processing unit parses the received information to understand the packet. The control logic/processing unit may be physically implemented in a variety of technologies. For example, it may be a general-purpose processor, executing a set of instructions from an internal or external storage device. In another embodiment, a dedicated hardware device having embedded instructions or state machines may be used to perform the functions described. Throughout this disclosure, the terms “control logic” and “processing unit” are used interchangeably to designate an entity adapted to perform the set of functions described. The WKP also contains software capable of performing the functions described herein. The software may be written in any suitable programming language and the choice is not limited by this disclosure. Additionally, all applications and software described herein are computer executable instructions that are contained on a computer-readable media. For example, the software and applications may be stored in a read only memory, a rewritable memory, or within an embedded processing unit. The particular computer on which this software executes is application dependent and not limited by the present invention.

In other embodiments, the WKP is a software module, which implements the functions described herein. The software may be written in any suitable programming language and the choice is not limited by this disclosure. Additionally, all applications and software described herein are computer executable instructions that are contained on a computer-readable media. For example, the software and applications may be stored in a read only memory, a rewritable memory, or within an embedded processing unit. In this embodiment, the particular network component on which this software executes is application dependent and not limited by the present invention. For example, the WKP may be a software module embedded in the GGSN, SGSN, or other core network components.

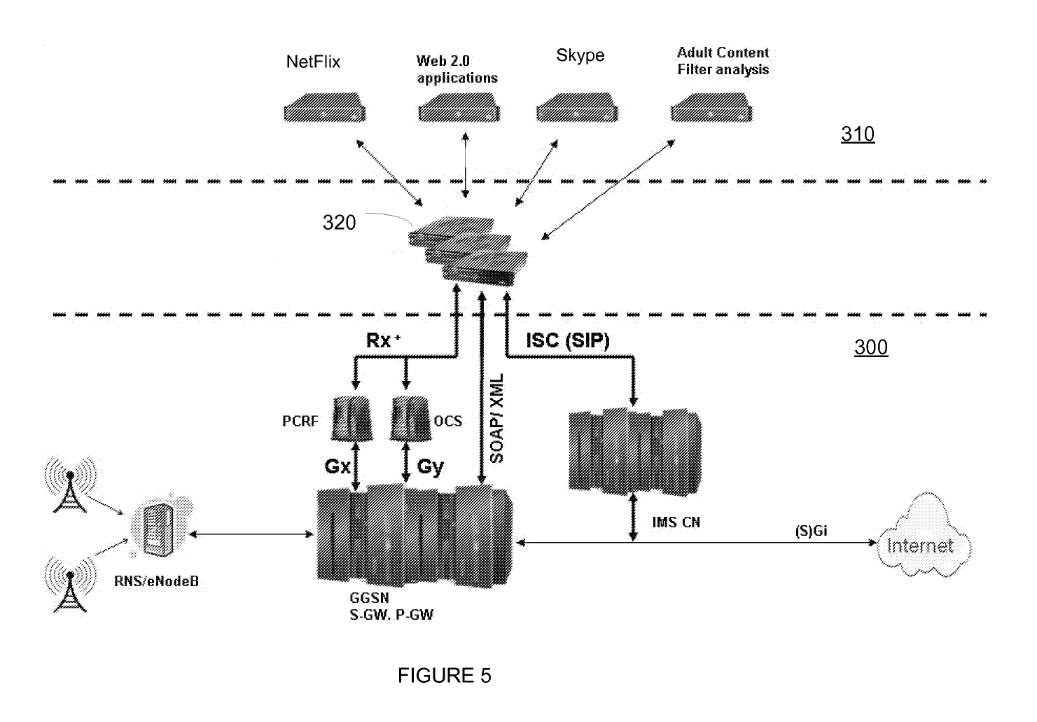

FIG. 5 illustrates how the WKP can be integrated into a PLMN. In this figure, the traditional mobile access network 300, such as 3G or 4G network, consists of components, such as the GGSN, SGSN, S-GW, P-GW, PCRF, OCS, and NodeB. One path through the access network leads to the internet, as shown in the Figure. In addition, the RX interface is an interface that is typically between the application function (AF) and the PCRF, which is used to insure that the required content meets the policy rules of the network. These rules include content restrictions, QoS, bandwidth and other parameters. This Rx interface is also used to communicate with the mobile access network 300 according to the present invention.

The service plane 310 consists of various services or applications that are presented to the UE via the mobile access network 300. As described above, many of these applications may have QoS requirements that exceed “best effort” and may require guaranteed bandwidth or delay limits or error tolerance. Such service use the same IP/TCP/UDP, HTTP etc., transport mechanisms as other internet based applications. In the prior art, there is no way for these services and applications to inform the access network 300 to modify or allow these services or applications.

The WKP 320 is logically positioned between the service plane 310 and the access network 300. As such, the applications and services in the service plane 310 may communicate with the WKP 320 to set or modify parameters for a specific transaction or session. In one embodiment, the interface used between the service plane 310 and the WKP 320 is Representational State Transfer (REST). In another embodiment, this may be a Service-Oriented Architecture (SOA) based SOAP/XML interface.

When the ASP wishes to reconfigure the mobile access network 300, it uses an application to communicate with the WKP 320. For example, the ASP may wish to provision more bandwidth to a user's service flows, based on a pre-paid subscription, such as the purchase of a movie, or initiation of a video conference. The ASP application communicates with the WKP 320, using the protocols established by the WKP 320 to provide certain information to the WRP 320. This information may include the identity of the UE, the identity of the IP flow or tunnel, and the requested configuration parameters. The ASP is aware of the application session information because the UE sets up an end to end application session with the ASP. The ASP may determine the UE's identity based on its own subscription database, or via header enrichment from the packetcore.

Note that this application session is different than the IMS-Session based AF in the prior art. In the prior art, within the IMS control plane, the UE/IMS client application establishes a session that the IMS control plane through the UMTS Control Plane, which then establishes a IP-CAN for user's user plane session. In contrast, in the present invention, the IP-CAN session is established for internet access for internet service. This user plane session is for any internet content access both for ASP server (for example NetFlix WebSite) and other sites. The user then accesses the ASP site (through normal TCP/HTTP mechanisms), and logs on to his account on the server without requiring additional PLMN control plane interactions. Thus, the present invention utilizes information in the user plane to modify QoS settings for a flow, while the prior art relied on information from the control plane.

The WKP 320 then relays this information to the access network 300, via the RX interface. Since additional information, other than that defined in the 3GPP, is passed via the RX interface, the term “RX+ interface” is used to denote this added functionality. Other currently defined interfaces, such as SOAP/XML and ISC are also used to communicate to components with the access network 300. For example, in one embodiment, there may be a logical connection from the WKP 320 to the access network 300, such as PCEF (GGSN/SGSN) in the event that a PCRF is not deployed. This interface may be SOAP/XML based.

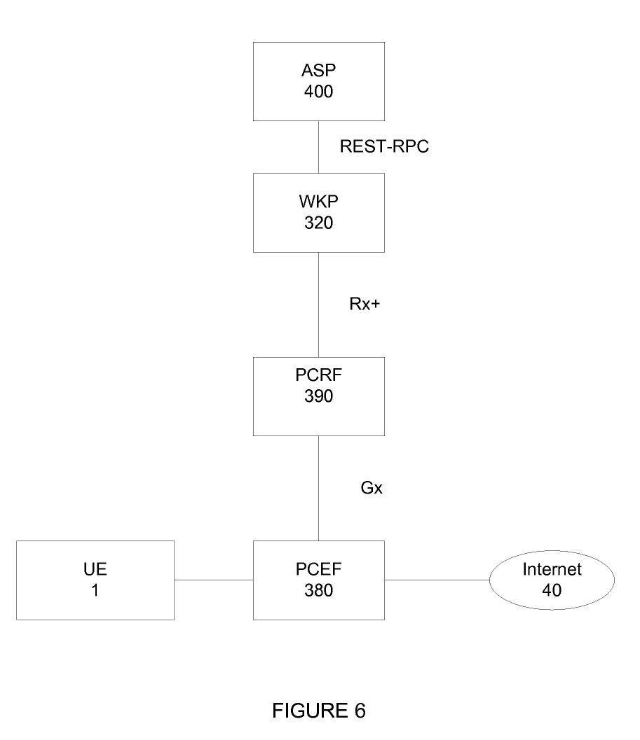

FIG. 6 shows a block diagram of the various components involved in the present invention. As described above, an ASP 400 may wish to modify the QoS parameters for a particular UE 10 for a particular IP flow. To do so, it communicates with the WKP 320, such as using REST-RPC or another protocol, such as SOAP/XML interface. In one embodiment, the WKP 320 may define a specific protocol and make that protocol available to all ASPS 400 for program and application development. For example, the ASP 400 may specify the range of source TCP or UDP Port numbers that it would use for the enhanced services, or it may specify the IPTOS fields that would use for these services and the corresponding QoS parameters such as bandwidth (guaranteed and maximum bit rates), delay tolerance, error tolerance etc.). The WKP 320, in turn, maps these service requirements to rules in the PCRF 390. These rules could be per flow based policies, as defined in the PCC Architecture.

The WKP 320 then relays this information to the PCRF 390 using the RX+ interface. The PCRF 390 communicates with the PCEF 380 using the standard Gx interface. The UE 1 receives the selected IP flow from the internet 40, based on the policy rules downloaded from the PCRF 390 and PCEF 380.

Having defined the location of the WKP 320 in the network and its interfaces with the other components, an example will be used to better define its operation. In one embodiment, an application may want to insure that data is delivered to a user or UE with a guaranteed bit rate or latency. One such application may be a video application, such as but not limited to NetFlix. The present invention will be described using a hypothetical application example, termed “NetFlix SpeedBoost”. A user accesses the website using traditional IP based protocols, and selects a particular movie to watch. Since this access was non-IMS based, the AF and other prior art components are unable of the identity of this connection and its QoS needs. Therefore, in this example, in order to deliver a HD Movie content through a Wireless Mobile Network (such as UMTS, LTE, CDMA, WIMAX,), an Application Service Provider 400, such as NetFlix, needs to interact with operator PLMN devices, such as the PCRF 390, to alter the service delivery attributes and charging (i.e. the Policy Charging and Control). While the 3GPP/PCC standards define methods for IMS based applications, these standards are not adequate for web-services. Therefore, the present invention identifies methods for providing such a speed boost. It is important note that “NetFlix Speed Boost” is a new client API module per the present invention that interacts with the WKP 320.

The Netflix SpeedBoost application module within the ASP 400 interacts with the WKP 320. As described above, the WKP 320 interacts with the PCRF 390 using the prior-art Rx procedures. Additional enhancements are required to support non-IMS AF functionality (Rx+). The PCRF 390 needs to know the information required to identify the service (such as via the ASP Application identifier and the ASP Application event identifier), for example to associate the service with different charging attributes, and/or determine priorities when access network resources are congested. The PCRF 390 also needs information to describe the identified IP flows that the ASP wants to have authorized. This information is passed to the PCRF 390 from the WKP 320.

There are various methods that can be used to identify IP flows. The most straight forward way to identify IP flows is using the standard 5-tuple approach.

Rx interface may be further enhanced, as the PCRF 390 may also need to know additional information about the duration and/or the volume, which is authorized by the ASP 400, because the ASP 400 does not necessarily know when the sponsored usage of the ASP service can be stopped (e.g. when the ASP 400 is not in the path of user plane). These parameters may also have to be added to the Rx signaling. For example, the ASP 400 may wish to authorize a higher QoS for the UE 1 for a session that lasts a specific amount of time (e.g. the duration of a movie). In this event, the WKP may keep track of the time that the IP flow has been established, and automatically downgrade the flow to default levels after the expiration of the specified time duration.

The charging systems and the PCRF 390 may need to be configured in the following way. A service specific Charging Key and Monitoring Key may be used for the service specific IP flows. This key is not shared with any other service of the UE in this PDN connection. These keys may be created by the PCRF based on PCRF database and configuration data. This allows the PCEF 380 to generate separate accounting and/or usage data records, specific for this service. Furthermore, the PCRF 390 also needs to know the ASPS that have a business relationship with the PLMN operator and the policies that are related to them, such as the QoS that is to be authorized for the sponsored IP flows.

The NetFlixSpeedBoost application module operating within the ASP 400 can initiate the session termination once the ASP service is stopped, for example, if movie streaming is complete.

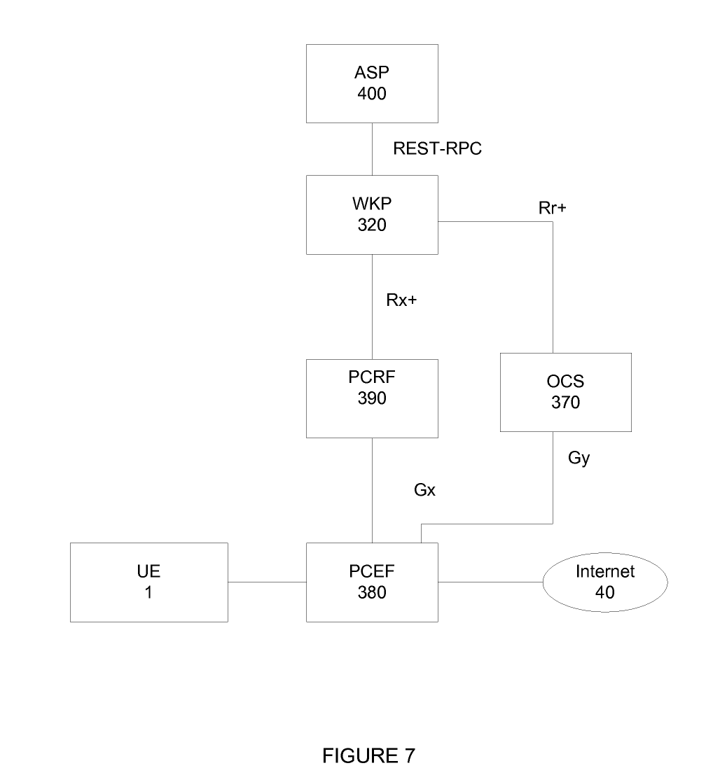

FIG. 7 shows an enhancement to the system of FIG. 6. In this figure, the WKP 320 also communicates with the online charging system (OCS) 370, through the Rr+ interface. This allows the ASP to provide expanded functionality. For example, an ASP 400 could offer some user 8 hours of SpeedBoost per month, while other users pay for 16 hours per month. The OCS 370 communicates with the PCEF 380 using the Gy interface, as is currently done.

As stated above, the RX interface is used to communicate between the WKP 320 and the PCRF 390. This section outlines extensions to the 3GPP Standards defined logical interfaces identified in the current invention. The Rx reference point between the AF and the PCRF is described in TS 23.203 and TS 29.214. In this embodiment, the Rx reference point is further enhanced to provide additional functionality, including:
Service information related to “SpeedBoost” application connectivity, such as the volume of the connectivity and any limits on the connectivity;
IP-CAN change notifications (e.g. when user moves from LTE to IWLAN)

The Rr interface, as shown in FIG. 7, may be enhanced to support credit authorization when the ASP service is started, as well as rating and hot billing of the service, for example, credit authorization for Skype traffic or specific types of applications/content within Skype, such Sky-Video, Skype-HD, Skype multi-Party video conference etc.

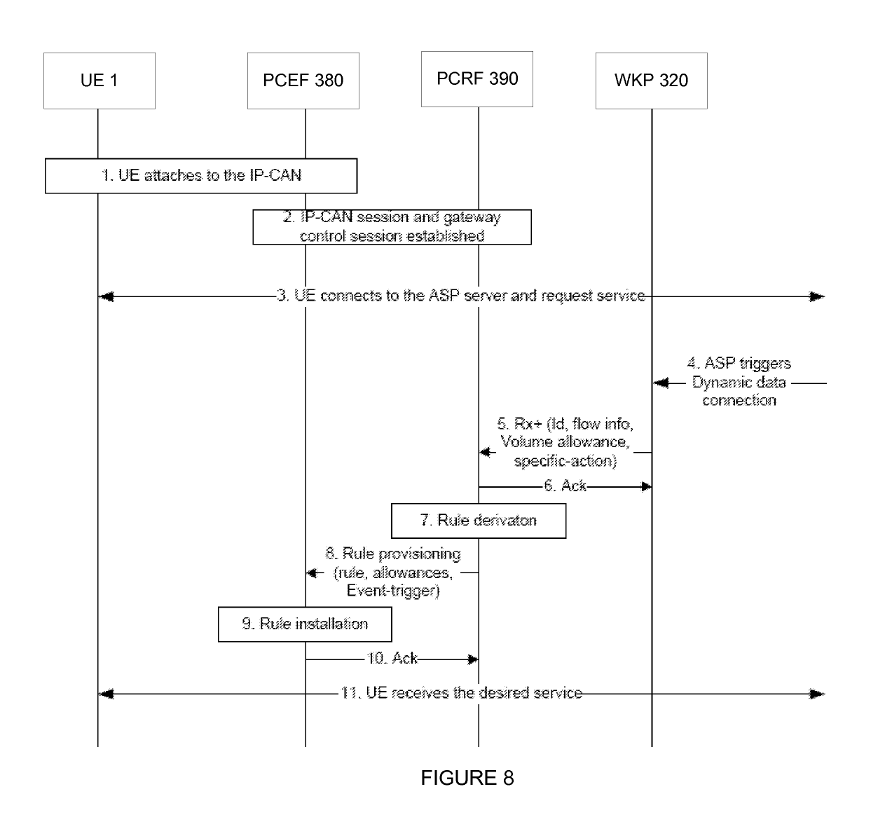

The following sections define and describe the call flows to demonstrate the PCC interaction for the SpeedBoost application under various scenarios. FIG. 8 shows call flows by which an ASP 400 interacts with the WKP 320 to provide enhanced QoS, while delivering a rich content such as a HD Stream through mobile-wireless network. The ASP 400 interacts with the WKP 320 using an ASP application module, such as NetFlixSpeedBoost as identified above.

In step 1, shown in FIG. 8, the UE attaches to the core network following the normal procedures specific to the IP-CAN, per the prior art 3GPP/PCC specification (TS23.203).

In step 2, the PCEF 380 and/or the Bearer Binding and Event Reporting Function (BBERF) establish IP-CAN session and/or gateway control session toward the PCRF 390 following the procedures described in TS 23.203. The UE's IP connection may have a limited data usage, in terms of bandwidth or total byte count. The established IP-CAN session may be used by the UE 1 for normal internet browsing per prior-art methods.

In step 3, the UE 1 accesses the ASP website (for example NetFlix web-site), such as by using a web browser or application specific to the mobile device. The UE 1 finds specific content of interest, such as a movie. The UE 1 then selects the content of interest and connects to the 3rd party ASP (e.g. NetFlix, Skype) server and requests services from the ASP using currently available methods.

In step 4, the ASP server determines, using various criteria such as member status, data plan, or other factors, that the SpeedBoost service should be used for the current user. The ASP server 400 then sends the REST-RPC request to WKP 320. The request includes the user identity to be boosted, such as the IP address and/or MSISDN. It also includes the IP flow information, the usage amount (QoS, time allowed) to be sponsored and the threshold request related to the SpeedBoost application connectivity.

In step 5, the WKP 320 interprets the incoming information. For each SpeedBoost application connectivity request, the WKP 320 establishes an Rx+ session toward the PCRF 390 as described in TS 23.203 & TS 29.214. It then provides the identity of the WKP 320, the user identity and the service information, which optionally includes the volume allowance and specific-actions related to the service (e.g. monitoring of RAT change). Thus, the WKP 320 that incorporates the current invention methods performs functions similar to AF component in the prior PCC architecture. However, the main difference is, unlike the 3GPP/PCC/AF component, the WKP 320 interactions are not for IMS applications, but for WEB based services and applications.

In step 6, the PCRF 390 authorizes and acknowledges the service information received from the WKP 320.

In step 7, the PCRF 390 derives PCC/QoS rules related to the SpeedBoost application connectivity. These rules may be based on configuration information contained in the PCRF database.

In step 8, the PCRF 390 provisions the rules and event triggers for the SpeedBoost application connectivity to the PCEF/BBERF within the IP-CAN.

In step 9, the PCEF/BBERF installs the provisioned rules and event triggers.

In step 10, the PCEF/BBERF sends acknowledgement to the PCRF 390. At this point, the IP connection and/or specific flows between the UE 1 and the ASP have been provisioned according to the ASP's request.

In step 11, the UE is able to use the sponsored connectivity to receive the desired service from the ASP 400.

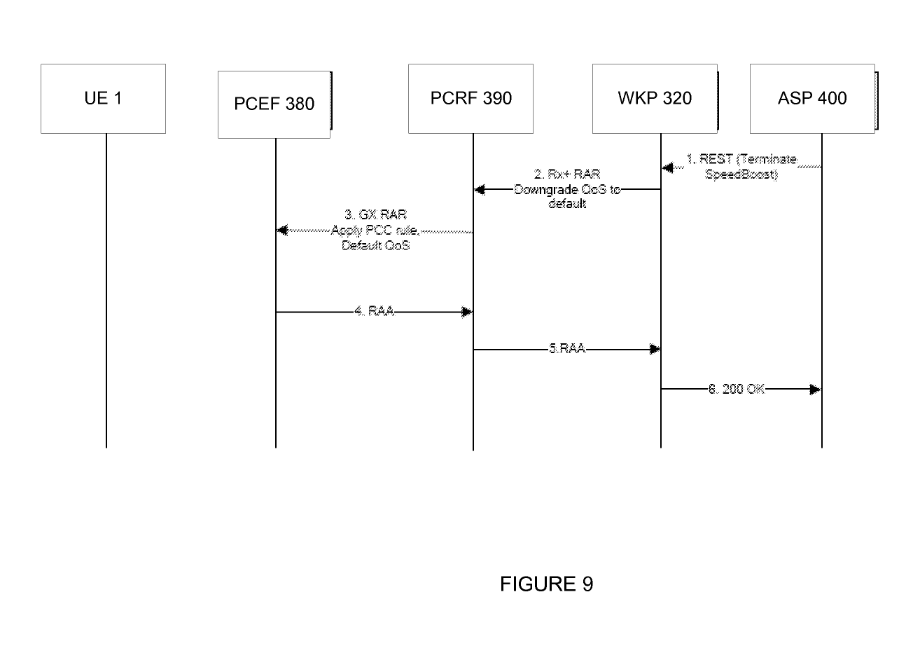

FIG. 9 shows the flow of actions that are used when the ASP 400 terminates the modified provisioning. For example, the ASP 400 may determine that the content being delivered, such as a movie, has terminated. At this point in time, the ASP 400 may wish to return the user to the default QoS parameter settings.

In step 1, the ASP 400 sends a REST message to the WKP 320, informing it to terminate the SpeedBoost application. This message may include the information supplied when the application was established in FIG. 8. For example, information such as IP address and/or MSISDN and IP flow information, may be supplied.

In step 2, the WKP 320 interprets the request and sends a communication to the PCRF 390, using the Rx+ interface, telling it to downgrade the performance for this particular IP flow to the default settings.

In step 3, the PCRF 390 determines the appropriate rules and forwards these rules to the PCEF 380 via the Gx interface. These rules instruct the PCEF to return this IP flow to its default settings.

In steps 4-6, acknowledgements are sent upstream to the ASP 400 indicating that the requested action has been completed.

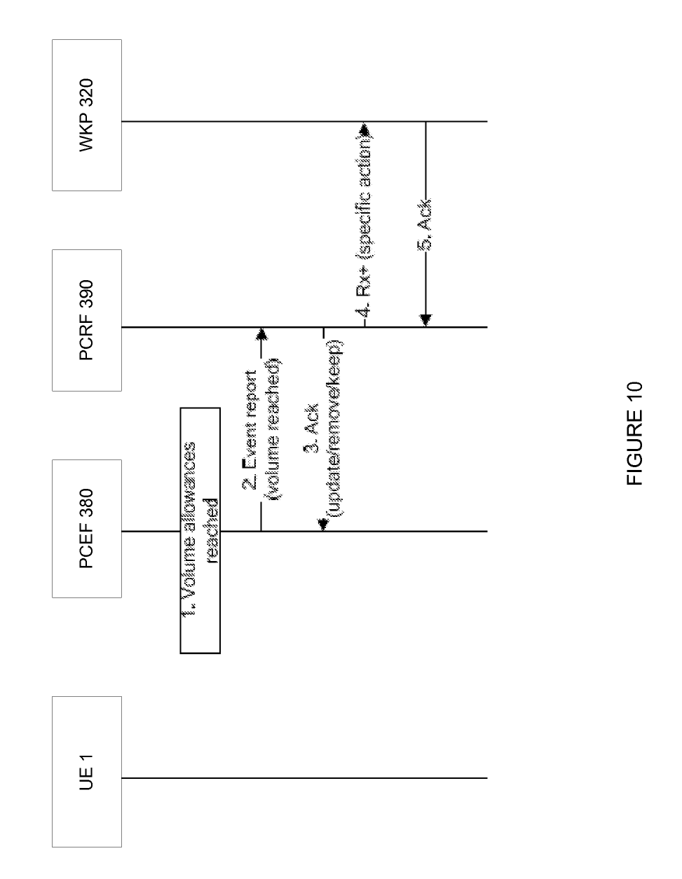

FIG. 10 shows a call flow that is used when the PCRF 390, PCEF 380 or OCS 370 determines that the time duration or byte count authorized by the ASP 400 has been reached.

In step 1, the allowance or quota has been reached. As stated above, this determination may be made by the PCRF 390, the PCEF 380 or the OCS 370.

In step 2, this event is reported to the PCRF 390 (if not originally determined by the PCRF). In some embodiments, the PCEF 380 sends an IP-CAN session modification request toward the PCRF 390 including an event trigger to indicate that the data usage has reached the volume threshold.

In step 3, the PCRF 390, based on information or rules previously received from the WKP 320 (or ASP 400), may update the threshold or remove the PCC rule and QoS rule related to the sponsored connectivity. For example, the PCRF 390 may have been previously authorized to update the threshold. In another embodiment, the PCRF 390 may have been previously instructed that the improved QoS settings should be revoked upon expiration of the time duration. In other embodiments, the PCRF 390 may also keep the same rules active but notify WKP 320 as described in the subsequent steps. In yet another embodiment, the PCRF 390 may send a message to the WKP 320 to determine how it should respond to this trigger event. In this example, the PCRF 390 may wait for a response from the WKP 320 before responding to the PCEF 380.

In step 4, the PCRF 390 sends a notification message, via the Rx+ interface to the WKP 320, informing it that the data usage or time duration threshold has been reached. If the PCRF 390 already took some action, such as extending the threshold, it will inform the WKP 320 of that action as well.

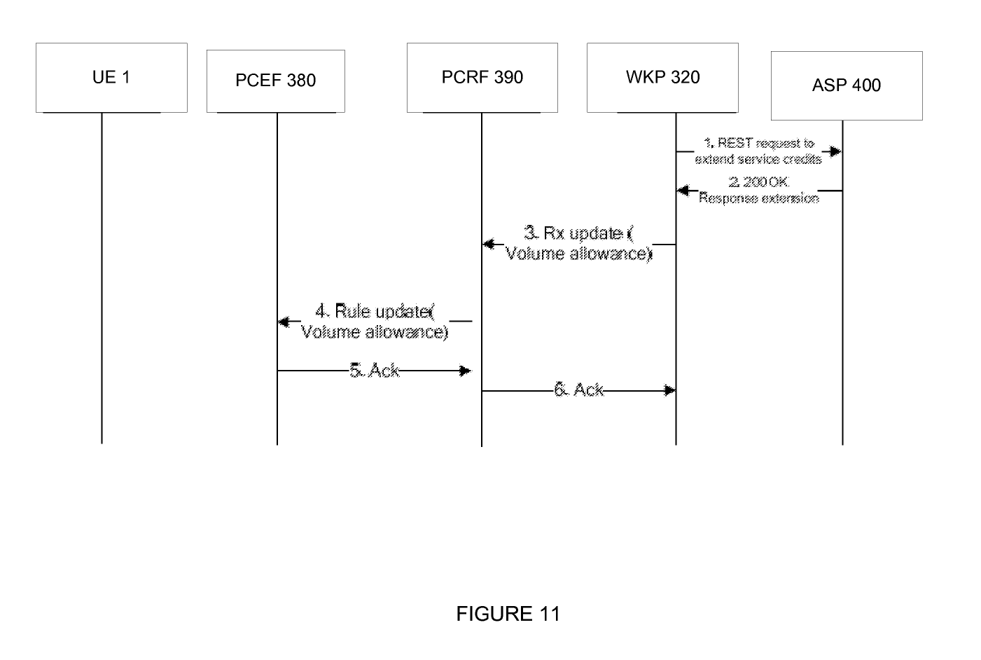

In step 5, the WKP 320 acknowledges the notification from the PCRF 390. If needed, the WKP 320 may invoke REST APIs to request more SpeedBoost credits from the ASP 400 using the procedures to extend the service or terminate the service, described below in conjunction with FIG. 11.

FIG. 11 shows a flow when the PCRF 390 or another component monitors usage, and determines that a change in QoS status may be needed. For example, the user may have signed up for 8 hours of premium service. In the middle of a movie, the time duration limit is reached. Rather than simply revert to the lower QoS parameters, the ASP may wish to ask the user if they wish to pay to extend the movie. In other scenarios, the ASP may use other criteria to allow a UE 1 to exceed the agreed upon time duration or allocated byte count. In this figure, the network, having determined that the threshold has been reached, initiates a dialog with the ASP 400 to determine the appropriate action.

In step 1, the WKP 320 sends a REST-RPC request to the ASP 400, informing the ASP 400 that the threshold has been reached. Optionally, the WKP 320 may request that the ASP increase the threshold.

In step 2, the ASP 400 sends a response to the WKP 320. This response may be agreeing to the suggested increase, or may define the specific parameters.

In step 3, the WKP 320 relays the new information to the PCRF 390 via the Rx+ interface.

In step 4, the PCRF 390 processes the new update and sends the updated rules to the PCEF 380.

In steps 5-6, acknowledgements are sent upstream, confirming the update has been made.

As was stated above, the Rx interface is enhanced to provide additional information between the WKP 320 and the core network 10. Some of these enhancements are described below. These commands are found in TS 29.214. The prior art RX interface in 3GPP standards is based on IMS-based multi media applications; Rx is enhanced for HTTP and other applications that are not IMS based in this invention. New methods to identify sessions as well as specify duration of speedboost by time or volume are defined as well. New methods for subscription of events are also required.

For example, in one embodiment, new AVP (attribute Value Pairs) are defined. One such new AVP may designate the duration of time (such as in seconds) during which the QoS service should be modified. Another new AVP may designate the length of time that the user has to use this improved QoS service. As an example, the user may purchase a movie, of duration 2.5 hours, and may be given 48 hours during which the movie must be viewed. In this example, the first new AVP would be 2.5 hours; while the second new AVP would be set to 48 hours.

The above example illustrates one aspect of the present invention. Specifically, an ASP uses a software application to access a new device, or a software module within a device, referred to as the WKP (web kit platform). This WKP is intended to provide the functionality of an AF for non-IMS web-based applications. The ASP application may indicate to the WKP that one or more of the QoS parameters, such as byte count, latency, and guaranteed bit rate, should be adjusted for a particular IP flow for a particular UE. The identification of the IP flow is performed using a method, such as that described above. The WKP then uses the Rx+ interface to pass these new rules to the PCRF, where they are implemented, as done today for IMS.

The WKP additionally defined a protocol between the ASP application and the WKP, such that all ASPS have a consistent and common interface on which to write these applications. Although different messages and protocols may be used, one such set of messages is described below.

One such message may be a location API. The Location API may be used for developers who want to track a particular mobile station. A variety of applications can use this information such as navigation services and targeted advertisements. Only supported HTTP method for this API is GET. There are mandatory parameters required in the API, such as Telephone Number and Version Number. Successful response contains the geodetic information for the mobile phone (longitude, latitude, altitude, accuracy etc).

GET http://example.com/services/getLocation
<?xml version=“1.0”?>
<getLocation version=“1.0”>
<address>tel:+441234567890</address>
</getLocation>

Responses to the Location API may be as described in the following table:

| Response | | |
|---|---|---|
| Code | Description | Response |
| 200 OK | Location | HTTP/1.1 200 OK |
| | Successfully | Content-Type: application/json |
| | Retrieved | Content-Length: 1234 Date: Thu, 04 |
| | | Jun 2009 02:51:59 GMT |
| | | {“terminalLocationList”: |
| | | {“terminalLocation”: { |
| | | “address”: “tel:+441234567890”, |
| | | “currentLocation”: { |
| | | “accuracy”: “100” |
| | | “altitude”: “1001.0 ”, |
| | | “latitude”: “−80.86302”, |
| | | “longitude”: “41.277306”, |
| | | “timestamp”: “2009-06- |
| | | 03T00:27:23.000Z” |
| | | }, |
| | | }}} |
| 404 | Failed to get | HTTP/1.1 404 NOT FOUND |
| | location | Content-Type: text/xml <error> Bad |
| | information, no | Address specified</error> |
| | resource exists | |
| 500 | Internal Error. | HTTP/1.1 500 Internal Server Error |
| | Failed to get the | Content-Type: text/xml Content- |
| | location | Length: 1234 Date: Thu, 04 Jun 2009 |
| | information | 02:51:59 GMT <error> Internal Error |
| | | within the Gateway</error> |
| 405 | Method Not | HTTP/1.1 405 Method Not Allowed |
| | Supported. Only | Content-Type: text/xml Content- |
| | supported | Length: 1234 Date: Thu, 04 Jun 2009 |
| | method is “GET” | 02:51:59 GMT |
| | | <error> Non Supported Method |
| | | Invoked </error> |

A second message may be a query of QoS parameters for a particular device. The Query QoS API is designed for developers who want to find information about Quality Of Service parameter for a device. This information can be used in applications that are streaming down data to the device, for example, to choose the right encoding format that fits within the capability allowed for the subscriber. When retrieving the QoS information for a specific subscriber, the MSISDN of the subscriber is used as the key. However, when updating the QoS for a particular session is concerned, information about source and destination addresses, and the protocol type may be required.

GET http://example.com/services/getQoS
<?xml version=“1.0”?>
<getQoS version=“1.0”>
<address>tel:+441234567890</address>
</geQoS>

Possible responses may be as follows:

| Response | | |
|---|---|---|
| Code | Description | Response |
| 200 OK | QoS Successfully | HTTP/1.1 200 OK |
| | Retrieved | Content-Type: application/json |
| | | Content-Length: 1234 Date: Thu, 04 |
| | | Jun 2009 02:51:59 GMT |
| | | {“terminalQoSList”: |
| | | {“terminalQoS”: { |
| | | “address”: “tel:+441234567890”, |
| | | “QoS”: 64 |
| | | }}} |
| 404 | Failed to get QoS | HTTP/1.1 404 NOT FOUND Content- |
| | information, no | Type: text/xml <error> Bad Address |
| | resource exists | specified</error> |
| 500 | Internal Error. | HTTP/1.1 500 Internal Server Error |
| | Failed to get the | Content-Type: text/xml Content- |
| | QoS information | Length: 1234 Date: Thu, 04 Jun |
| | | 2009 02:51:59 GMT <error> Internal |
| | | Error within the Gateway</error> |
| 405 | Method Not | HTTP/1.1 450 Method Not Allowed |
| | Supported. Only | Content-Type: text/xml Content- |
| | supported methods | Length: 1234 Date: Thu, 04 Jun |
| | are “GET” and | 2009 02:51:59 GMT <error> Non |
| | “POST” | Supported Method Invoked</error> |

A third message may be an update of QoS parameters for a particular device. The Update QoS API is designed for developers who want to modify information about Quality Of Service parameter for a device.

POST http://example.com/services/updateQoS
<?xml version=“1.0”?>
<updateQoS version=“1.0”>
<srcIpAddr>10.10.1.120</srcIpAddr>
<srcPort>24567</srcPort >
<dstIpAddr>10.1.10.200</dstIpAddr>
<dstPort >34567</dstPort>
<proto>UDP</proto>
<QoS>128</QoS>
</updateQoS>

Possible responses to this message are as follows:

| Response | | |
|---|---|---|
| Code | Description | Response |
| 200 OK | QoS Successfully | HTTP/1.1 200 OK |
| | updated | Content-Type: application/json |
| | | Content-Length: 1234 Date: Thu, 04 |
| | | Jun 2009 02:51:59 GMT |
| | | {“terminalQoSList”: |
| | | {“terminalQoS”: { |
| | | “srcIpAddr”: 10.10.1.120, |
| | | “srcPort”: 24567, |
| | | “dstIpAddr”: 10.1.10.200, |
| | | “dstPort”: 34567, |
| | | “proto”: UDP, |
| | | “address”: “tel:+441234567890”, |
| | | “QoS”: 128 |
| | | }} |
| 404 | Failed to update | HTTP/1.1 404 NOT FOUND |
| | QoS information, | Content-Type: text/xml <error> Bad |
| | no resource exists | Address specified</error> |
| 500 | Internal Error. | HTTP/1.1 500 Internal Server Error |
| | Failed to update | Content-Type: text/xml Content- |
| | the QoS | Length: 1234 Date: Thu, 04 Jun |
| | information | 2009 02:51:59 GMT <error> Internal |
| | | Error within the Gateway</error> |
| 405 | Method Not | HTTP/1.1 405 Method Not Allowed |
| | Supported. Only | Content-Type: text/xml Content- |
| | supported methods | Length: 1234 Date: Thu, 04 Jun |
| | are “GET” and | 2009 02:51:59 GMT |
| | “POST” | <error> Non Supported Method |
| | | Invoked </error> |

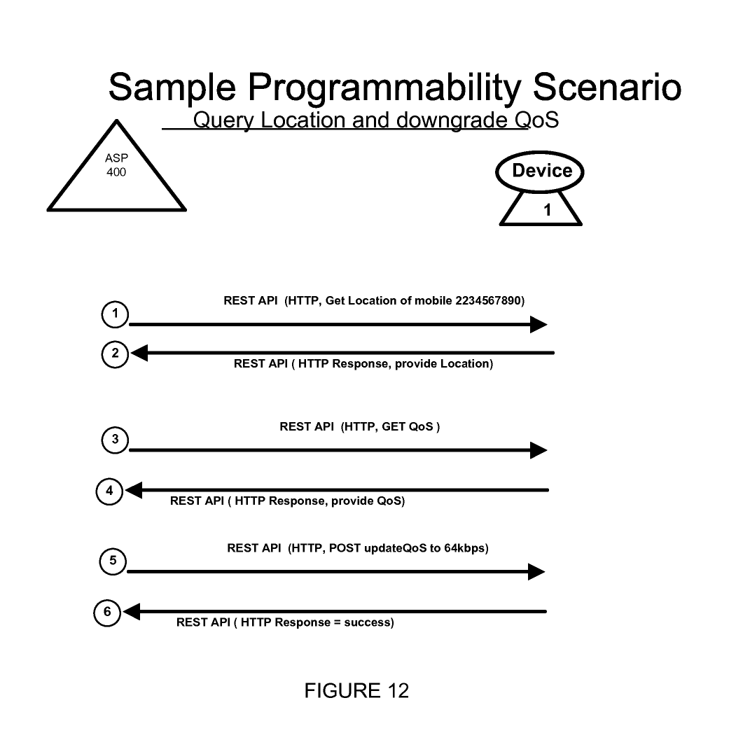

FIG. 12 shows another example using the WKP of the present invention. In this example, the ASP (which may be the PLMN operator for example) queries the UE to determine its location (step 1). The WPK translates this request and passes the request to the appropriate access network component. It then returns the location of the device (step 2). Note that this functionality is currently available. The ASP then queries the UE to determine its current QoS settings (step 3), and subsequently receives this information from the WKP (step 4). If the ASP determines that that quality of service is not available at that location, the ASP may then downgrade the QoS for this UE (step 5). In other embodiments, the ASP may increase the QoS settings. The change is relayed to the PCRF and the change is acknowledged to the ASP (step 6). Of course, other scenarios are also possible. These figures are meant to illustrate possible ways to use the present invention, and are not intended to limit the invention to only these embodiments.

The above methods also allow other applications. For example, the PLMN service provider may offer end users an application by which they can pay to temporarily increase their QoS parameters. For example, a user may access a portal or specific website, which is hosted by the PLMN operator. This website may allow the end user to purchase additional bandwidth for a fixed fee, such as $1 per hour of premium service. Such an arrangement may be of interest to users who occasionally use video conferencing or operate a SlingBox to stream content from their homes. The PLMN, in this example, may then create its own ASP application, as was described above. Using the mechanisms described above, the PLMN can then increase the user's bandwidth as agreed upon.

Another aspect of the invention identifies an Open API for control points in a transit network device such as SGSN, GGSN, SGW or other components. In the current devices, these control points are internal to the device, and the device reacts to incoming traffic, and these triggers are not available external to the device. If these triggers are exposed through an API using XML (as shown in FIG. 5), then the WKP could use the API for controlling the network device, in addition to interacting with PCRF. This part of the invention may need to be implemented in a Gateway network device as software module.

In one aspect, the WKP comprises a software program that resides within the mobile network, such as between the service plane and the core network. This software program has a first module that defines a set of APIs for use by ASP applications. These applications may include means to obtain and update the QoS parameters of a particular UE. The WKP also has a second module that communicates with the PCRF via the RX interface to provide updated QoS parameters and to obtain the current QoS parameters.

In another aspect, the present disclosure provides a system and method to allow provisioning of QoS parameters to certain IP flows in a wireless radio access network. These particular IP flows are based on the content within a particular user plane. In the prior art, IMS uses control plane to establish enhanced QoS services for a session. In the present invention, information from the user plane is used to establish these enhanced services. To do this, the application service provider (ASP) must be able to determine when enhanced services are required, and which IP flows should receive these services. A new software application module, resident or associated with the ASP, provides this new functionality. The ASP, upon determining that a user or UE should receive upgraded services, notifies a logical device, referred to as the WKP, that it wishes to modify the QoS parameters for a particular IP flow. This notification is done utilizing this new ASP application module. This flow may be a TCP flow, or a UDP flow. The ASP application module identifies the particular flow that the ASP wants to modify based on its characteristics, such as IP source, IP destination, IP Source port, IP Destination port, and protocol type (5-tuple). The ASP application module and the WKP 320 communicate using a set of APIs that allow the ASP 400 to obtain and modify the QoS parameters of a particular IP flow.

Once the particular IP flow to modify has been identified, the WKP 320 passes this information to the PCRF 390 using the Rx interface. The PCRF 390 propagates this further to the PCEF 380, as shown in FIG. 9. This process allows the particular flow to be properly provisioned. Mechanisms are also provided for terminating this provisioning, based on a request from the ASP, or based on a threshold event, as shown in FIGS. 9 and 10, respectively. It is important to note that these IP flows are created and provisioned at the user plane. In other words, it is the specific content that is to be transmitted in this flow that determines whether it should be provisioned for higher QoS settings. For example, a UE may access a particular website, such as NetFlix or use Skype as a transport for a streaming a HD video content, or for a multi-part video conference. The establishment of this flow is not significant, as web accesses can typically be performed using default QoS settings. However, if the user were to request that the website deliver an HD movie, and optionally, pays a premium for this service, the flow becomes significant. In this case, the user may be entitled to enhanced service to insure a guaranteed bit rate and latency. Therefore, only the ASP is in a position to determine when a QoS change should be made.

This disclosure describes a method of provisioning non-IMS IP flows. This task presents various challenges that are not easily solved using the current PCC and IMS protocols. For example, the current protocols are IP-CAN based. As such, these specially provisioned flows can be set up using information from the control plane. In other words, information from the control plane is sufficient to determine the identity of a flow that should be specially provisioned. Furthermore, this provisioning typically lasts for the duration of the session, as the session is specifically established for this purpose, such as a SIP session.

In the present invention, it is impossible for any component within the wireless network, other than the ASP, to determine that a particular IP flow must be provisioned. This is because the control plane does not contain any information that would identify this IP flow as needing higher QoS settings. In fact, even the IP source and IP destination are insufficient to denote a particular IP flow. As described above, a web access to the NetFlix site is not in need of QoS provisioning, however, the playback of a movie from that site might be. In addition, users access internet/web services via browsing/searching and identify content or services of interest in an interactive manner, migrating in and out of these applications that require different QoS metrics. Triggering new sessions through the 3GPP Control Plane for these services increases control plane traffic and does not easily scale. Additionally, when such services are accessed from the internet/web through a browser or a specialized application, the user device may establish many TCP/UDP applications flows to the same server/website or multiple websites (for example for promotional objects in the sidebar of a web-page, such as advertisements), and only a small number of these application flows actually need special treatment. In other words, not all the flows within the User's IP session through Access network need to have improved QoS settings.

These significant differences in how the IP flow are created and determined imply that all prior art methods of determining and provisioning higher QoS flows are completely inappropriate in this context. In fact, the only method that can be used is for the ASP itself to inform the wireless network of the identity of a particular IP flow that it has determined must be provisioned for higher bandwidth.

To implement this, a new ASP application module must be created which identifies the IP flow and communicates with the newly created WKP module. This ASP application module does not currently exist, as there is no present mechanism whereby an ASP can alter the provisioning of a wireless network. The ASP application module may be written in any suitable programming language and the choice is not limited by this disclosure. Additionally, all applications and software described herein are computer executable instructions that are contained on a computer-readable media. For example, the software and applications may be stored in a read only memory, a rewritable memory, or within an embedded processing unit. In this embodiment, the particular component on which this software executes is application dependent and not limited by the present invention. For example, the ASP application module may be a software module embedded in the ASP web-server, or another computer associated with the ASP.

This ASP application module communicates with the wireless network to modify the QoS settings for a particular IP flow. In one embodiment, a dedicated hardware component is introduced, which contains the functionality of the WKP described above. In another embodiment, the functionality of the WKP is embedded in a currently existing component, such as a GGSN or SGSN. The ASP application module communicates with the WKP using a set of APIs, which allow the ASP to identify the IP flow, such as using the 5-tuple approach. The WKP then communicates this new provisioning information to the PCRF and PCEF, using the Rx interface. However, to fully implement this mechanism, enhancements to the Rx interface must be included, to allow the components to determine what the special provisioning should be terminated. This is necessary because the flow may not terminate when the enhanced QoS provisioning terminates. In other words, the IP session between the ASP and the UE may still be active, even after the movie has completed. Thus, the creation and termination of the flow are not useful in determining when and for how long an enhanced QoS flow should be created. Thus, the ASP application module also supplies information concerning the time duration for which the QoS parameter should be modified. In another embodiment, the ASP may also indicate that the QoS parameters must be modified within a predetermined period. For example, if the UE purchases a movie that is 2 hours long, the ASP application module may inform the WKP that the QoS parameter must be modified for a period of two hours. The ASP application module may further specify that the UE must attempt to view this movie within 2 days. These concepts are not contemplated in the current IMS protocols.

In another embodiment, the other network components, such as the PCRF, PCEF and GGSN, have external triggers, which can be made visible to the WKP. For example, the PCEF may determine that the 2 hour limit has elapsed. This triggering event can then be communicated to the WKP, as shown in FIG. 10. This allows the WKP to determine whether to extend this provisioning or to return to the default levels.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of adjusting a QoS parameter for a IP flow through a wireless radio network, comprising:
accessing a website, associated with an application service provider (ASP), using a mobile device over said wireless radio network;
determining whether said access requires QoS parameters different than those currently assigned to said mobile device;
using an ASP application module to communicate with a second software module using a predetermined protocol, said second software module executing on a computing device, wherein said computing device is in communication with components in said wireless radio network, whereby said ASP application module requests an adjustment in said QoS parameter for said mobile device; and
using said second software module to communicate said requested adjustment to said components in said wireless radio network.

2. The method of claim 1, wherein said ASP application module identifies said IP flow using a 5-tuple scheme.

3. The method of claim 1, wherein said ASP application module identifies the time duration for which said QoS parameter of said IP flow should be adjusted.

4. The method of claim 1, wherein said ASP application module identifies the time interval during which said QoS parameter must be adjusted.

5. The method of claim 1, wherein said computing device comprises a dedicated network device.

6. The method of claim 1, wherein said computing device comprises a GGSN.

7. The method of claim 1, wherein said computing device comprises a SGSN.

8. The method of claim 1, wherein said second software module utilizes a Rx interface to communicate said requested adjustment to said components.

9. A software program, comprising instructions stored on a computer readable media, for adjusting QoS parameters within a wireless radio network, based on requests from an application service provider (ASP), comprising:
a first module comprising a plurality of APIs for communicating with said ASP; and
a second module comprising instructions for accessing a PCRF using an Rx interface.

10. The software program of claim 9, wherein said ASP uses said APIs to specify an IP flow using 5-tuple format.

11. The software program of claim 9, wherein said second module utilizes said Rx interface to inform said PCRF of the time duration for which said QoS parameter of said IP flow should be adjusted.

12. The software program of claim 11, wherein said second module utilizes said Rx interface to inform said PCRF of the time interval during which said QoS parameter must be adjusted.

13. The software program of claim 11, further comprising a third module, located in said PCRF, which tracks the time duration during which said QoS parameter has been adjusted.

14. The software program of claim 13, wherein said third module communicates expiration of said time duration to said second module.
